(19) United States
(12) Patent Application Publication
(10) Pub. No.: US 2021/0164114 A1
(43) Pub. Date: Jun. 3, 2021

(54) PRECURSOR MATERIALS AND METHODS FOR THE PREPARATION OF NANOSTRUCTURED CARBON MATERIALS

(71) Applicant: NORTHEASTERN UNIVERSITY, Shenyang, Liaoning (CN)

(72) Inventor: Ali Reza KAMALI, Shenyang, Liaoning (CN)

(21) Appl. No.: 16/980,769

(22) PCT Filed: Jul. 24, 2019
(86) PCT No.: PCT/CN2019/097491

§ 371 Date: Sep. 14, 2020

(30) Foreign Application Priority Data
Jun. 6, 2019 (CN) 201910489282.9

(51) Int. Cl. C25B 1/135

(52) U.S. Cl. CPC C25B 1/135

(57) ABSTRACT

The present invention belongs to the field of carbon materials and provides a precursor material and method for the preparation of carbon nanostructures. The invention directly uses rocks or mixtures of carbon raw materials with metal or metal oxide catalysts to prepare precursor materials. The precursor material is then wrapped by using metal wires and polarized in a molten salt system to prepare the nanostructured carbon material. Metals or metal oxides scattered in the carbon phase act as catalysts for the generation of nanostructured carbon materials; this precursor material can be easily obtained from natural rocks or by artificially synthesizing. Nanostructured carbon materials are composed of carbon nanoparticles, carbon fiber and carbon nanotubes. The preparation process is simple and easy to implement, and the resulting nanostructured material has high conductivity and can be used as an active material or additive for use in energy storage devices.

### TECHNICAL FIELD

The present invention belongs to the field of carbon materials and relates to a precursor material and method for the preparation of nanostructured carbon materials.

### BACKGROUND

Carbon nanostructures including carbon nanofibers, carbon nanotubes and carbon nanoparticles, have unique properties such as high surface area, chemical and physical stability and electrical conductivity. These properties make carbon nanostructures particularly important for many applications including energy storage devices, composite materials and water purification. Various methods are used to produce carbon nanostructures. These methods are mostly based on the introduction of carbon from a gas phase involving a catalyst system.

The first method developed for producing carbon nanotubes and carbon nanoparticles in reasonable quantities was based on the application of an electric current across two carbonaceous electrodes in an inert gas atmosphere. This method, which is called plasma arcing, involves the evaporation of one electrode as cations followed by the deposition at the other electrode. Carbon nanostructures can also be produced by laser vaporization of graphite rods and the growth of carbon nanostructures on metallic catalysts.

Arc-discharge and laser vaporization are currently the principal methods for obtaining high quality carbon nanotubes. However, both methods suffer from several drawbacks, one of which is that both methods involve the evaporation of the carbon source, and therefore, the large scale production of carbon nanostructures by these methods is difficult and energy intensive.

Chemical vapour deposition methods are also used for the preparation of carbon nanostructures. In this approach, a hydrocarbons gas is decomposed over a metal catalyst at temperatures typically in the range of 600-1000° C. to produce various carbon materials such as carbon fibres and filaments. The chemical vapour deposition methods suffer from a low efficiency and high costs.

Therefore, the solid phase direct conversion of carbon materials into carbon nanostructures is of great significance for the large-scale production of low-cost carbon nanostructures, with low energy consumption.

### SUMMARY

The present invention relates to a precursor material which can be used for the direct conversion of solid carbon into carbon nanostructures. In the present invention, the carbon raw material is mixed with metal or metal oxide catalysts to prepare a precursor material. The precursor material is then wrapped using a metallic wire, and is cathodically polarized in a molten salt system to prepare said nanostructured carbon materials.

The technical solution of the present invention is as follows:

Precursor materials for the preparation of nanostructured carbon materials, wherein a carbon phase and a non-carbon phase are comprised, the non-carbon phase is scattered in the carbon phase, the characteristic elements of the non-carbon phase include at least one of Fe, Ni, Si, Co, Na, Mg, Al, K and Ca elements, the characteristic element of the non-carbon phase in the precursor material has a mass percentage of 0.1 to 5%, and the characteristic elements of the non-carbon phase are in the form of single elements, or their oxides; the carbon phase is amorphous carbon or crystalline carbon; and the particle size of the single elements or the oxides of the characteristic elements in the non-carbon phase is in the range of 1 nm to 100 μm.

The method for preparing nanostructure carbon materials using the above precursor materials includes the following steps, referring to FIG. 1:

Step 1, wrapping the precursor material (1) using a wire (2) made of Mo, W, Ni or steel with a dimeter 0.5-12 mm depending on the size of the precursor material (1). One end of the conductive rod A (3) is fixed into the precursor material (1), and the wire (2) is connected to the conductive rod A (3) during winding. The rod is made of Mo, W, Ni or stainless steel and has a diameter of between 6 mm to 5 cm depending on the size of the precursor material.

Step 2, the precursor material wrapped by the conductive wire and connected to the conductive rod is then located on the ceramic disc (5) at the bottom of the reaction container (4), the reaction container (4) is filled with a molten salt (6). The molten salt is LiCl, NaCl, CaCl₂, KCl or a mixture of them. The reaction container (4) is made of graphite, Mo or W;

Step 3, the temperature of the molten salt is reached to 350° C. to 900° C. The conductive rod B (7) is connected to the reaction container (4). The conductive rod (7) is the same material as the conductive rod B (3). The conductive rod A (3) is connected to the negative pole of a power supply, and the conductive rod B (7) is connected to the positive pole of the power supply;

Step 4, A direct electric current in the range of 1 to 10000 A, is applied between the conductive rods A (3) and B (7) for the duration of 10 min to 20 h, depending on the size of the precursor material; after the molten salt is cooled, the salt is dissolved in water and the suspension obtained is filtered to recover the nanostructure carbon material.

The ceramic disc (5) is made of Al₂O₃, MgO or ZrO₂. Said conductive rod B (7) and said conductive rod A (3) are made of Mo, W, Ni or stainless steel. The precursor material can produce nanostructured carbon materials in the reaction container in an atmosphere of argon, air, nitrogen, helium or a mixture of them. The nanostructured carbon materials obtained in step 4 mentioned above include carbon nanoparticles with sizes between 1 nm to 1000 nm, carbon nanofibers with diameters between 1 nm to 1000 nm and carbon nanotubes with outer diameters between 1 nm to 1000 nm.

Without being limited by mechanism, during of cathodic polarization of the precursor material, the metal oxides scattered in the carbon phase can be reduced to the corresponding metals, and the newly formed metals can act as catalysts to convert the carbon phase into carbon nanostructures.

Metals such as Fe, Ni, Co, Si, Na, Mg, Al, K or Ca scattered in the carbon phase can also be used as the precursor material. During the cathodic polarization of this precursor material, the thin oxide layer around the metal particles is reduced to the corresponding metal, and the resultant metal particles act as highly efficient catalysts to convert the carbon phase into carbon nanostructures.

The beneficial effect of the present invention is that the precursor material is composed of elemental carbon and metal oxides or metals randomly dispersed in the carbon phase; and the metal or metal oxides scattered in the carbon phase can act as catalysts to promote the generation of nanostructured carbon materials; the precursor material can be easily obtained from natural rocks or by artificially synthesizing. Nanostructured carbon materials include carbon nanoparticles, carbon fibers and carbon nanotubes.

The preparation process is simple and easy to implement, and the resulting nanostructured materials produced has high conductivity and can be used as active materials or additive for use in energy storage devices.

### DRAWINGS

FIG. 1 is a diagram of the precursor material used to prepare carbon nano structures.

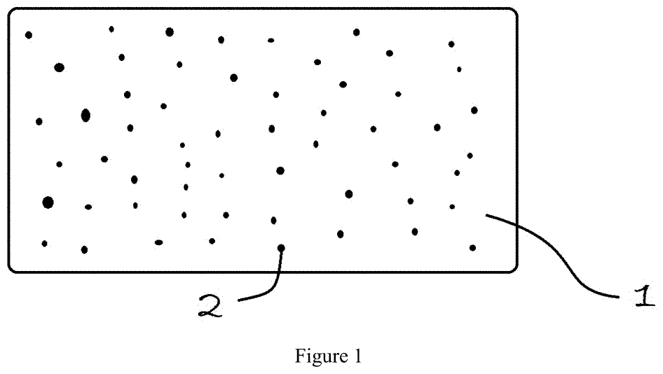

FIG. 2 is a diagram of the process used for preparing nanostructured carbon materials from the precursor material.

FIG. 3 is an SEM image of a rock material;

FIG. 4 is an EDX mapping analysis performed on the SEM image shown in FIG. 3;

FIG. 5 is an SEM image of the nanostructured carbon material;

FIG. 6 is an SEM image of carbon fibers; the area indicated in FIG. 6 was subjected to EDX analysis;

FIG. 7 is the Raman spectroscopy analysis of the nanostructured carbon material;

FIG. 8 is the lithium storage capacity of the nanostructured carbon material during 100 cycles at the current density of 75 mAg⁻¹;

FIG. 9 is the lithium storage capacity of the nanostructured carbon material during 100 cycles at the current density of 187 mAg⁻¹;

FIG. 10 is an SEM image of the purified nanostructured carbon material;

FIG. 11 is an SEM image of the nanostructured carbon material referred in Example 5;

FIG. 12 is an SEM image of the nanostructured carbon material referred in Example 6;

FIG. 13 is an SEM image of the nanostructured carbon material referred in Example 7.

Within figures mentioned above: A the carbon phase; B the non-carbon phase; 1 the precursor material; 2 conductive wire; 3 the conductive rod A; 4 the reaction container; 5 the ceramic disc; 6 the molten salt; 7 the conductive rod B.

### DETAILED DESCRIPTION

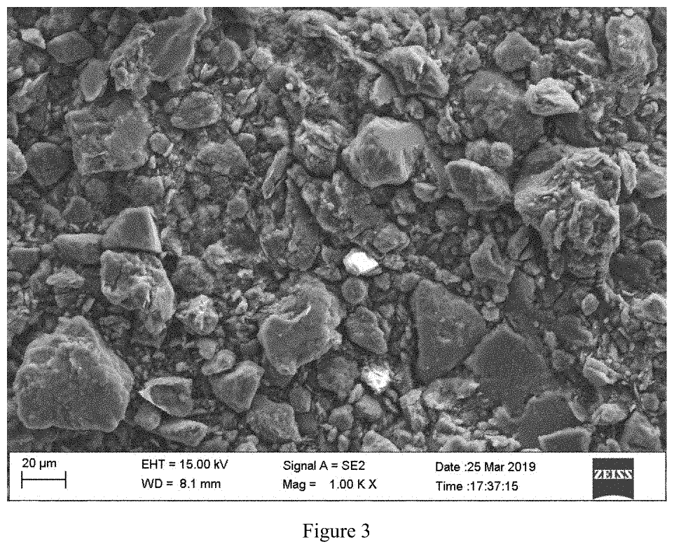

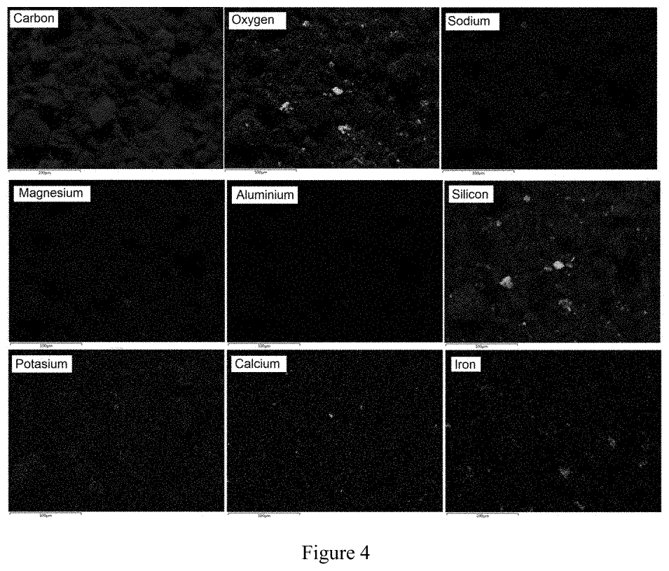

Example 1. A natural rock was used as the precursor material. The SEM morphology of the rock is shown in FIG. 3. The rock contains of grains with a size in the range of 1-60 μm. FIG. 4 shows the EDX-map analysis performed on the SEM micrograph shown in FIG. 3. As it can be seen, the material contains a relatively uniform distribution of various elements comprising of C, O, Na, Mg, Al, Si, K, Ca, Fe and other elements. The chemical composition of the rock is shown in the Table 1.

TABLE 1
The chemical composition of the rock
used as the precursor material.

| Element | wt % |
|---|---|
| C | 80.47 |
| O | 9.71 |
| Na | 0.14 |
| Mg | 0.09 |
| Al | 2.52 |
| Si | 3.78 |
| K | 0.31 |
| Ca | 0.13 |
| Fe | 2.85 |
| Total | 100.00 |

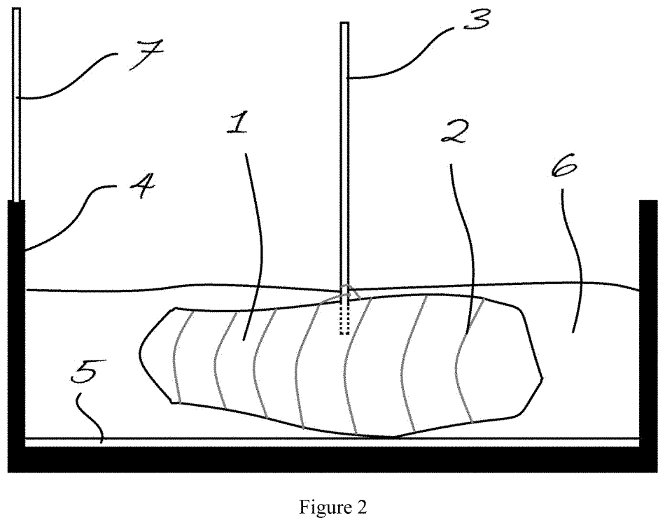

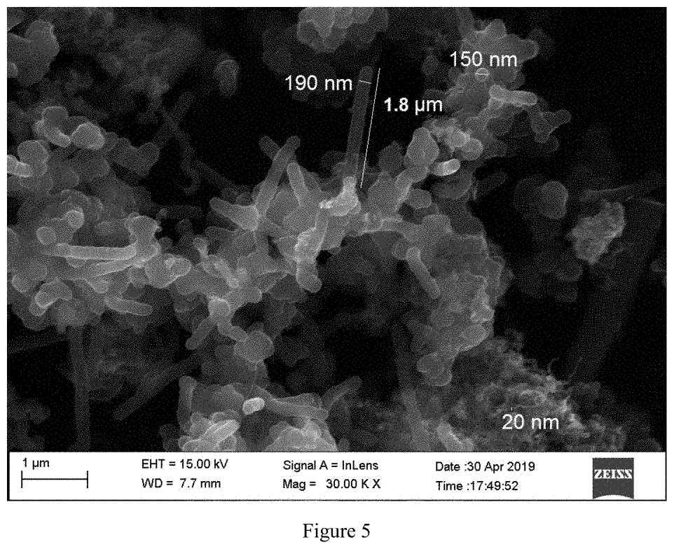

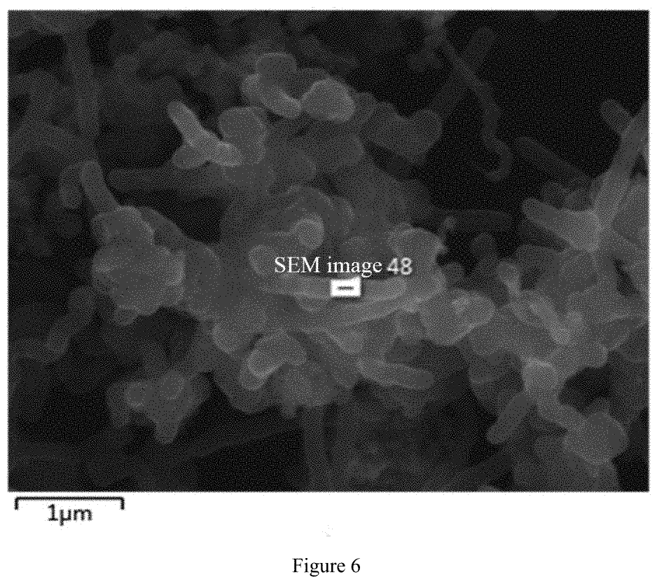

A rock of this material was wrapped using molybdenum wire; and a molybdenum rod was tightened into the rock. The reaction container shown in FIG. 2 was used for this experiment. A molten salt mixture containing LiCl (80 wt %), NaCl (10 wt %), KCl (5 wt %) and CaCl₂) (5 wt %) was used as the electrolyte. The rock was cathodicaly polarized in the molten salt at 750° C. A current of 30 A was passed between the rock and the graphite crucible used as the anode. The potential difference between the rock and a Pt reference electrode immersed in the salt was in the range of 1-10 V. The molten salt process was conducted for 2 h under N₂. Then, the system was cooled down and the salt was washed out with water, and the nanostructured carbon material produced was filtered and dried at 80° C. for 2 h. A SEM micrograph of the nanostructured carbon material produced is shown in FIG. 5, in which a mixture of carbon fibres, carbon nanotubes and carbon nanoparticles with the dimensions in the range of 10 nm to 2 μm can be seen. Another SEM image of the product is shown in FIG. 6. The EDX analysis performed on a carbon fibre shown in this Figure is exhibited in Table 2.

TABLE 2
Chemical composition of the area identified
on the carbon fibre shown in FIG. 6.

| Element | wt % | at % |
|---|---|---|
| C | 87.32 | 93.37 |
| O | 4.95 | 3.98 |
| Na | 0.12 | 0.07 |
| Al | 0.12 | 0.06 |
| Si | 0.96 | 0.44 |
| Cl | 3.43 | 1.24 |
| K | 1.10 | 0.36 |
| Ca | 0.27 | 0.09 |
| Fe | 1.73 | 0.40 |
| Total | 100.00 | 100.00 |

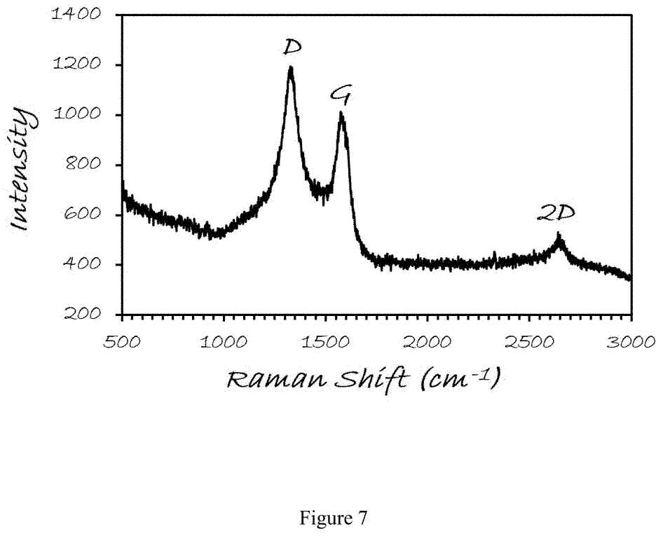

Raman spectrum of the nanostructured carbon material produced is shown in FIG. 7, where the presence of D, G and 2D bands is evident. The Raman results are consistent with the microscopic results showing the formation of nanostructured carbon materials.

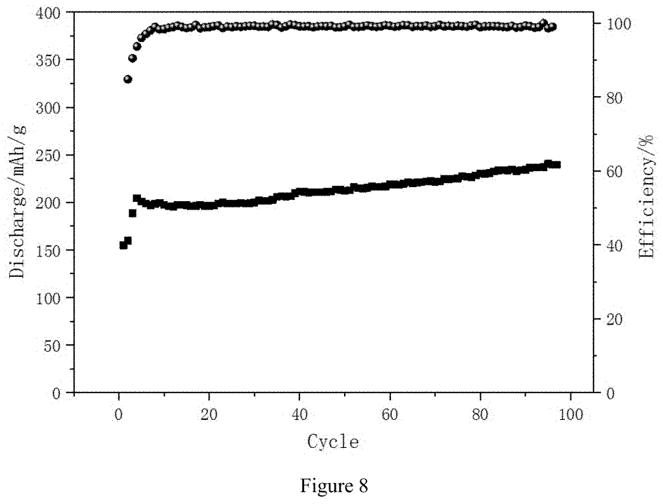

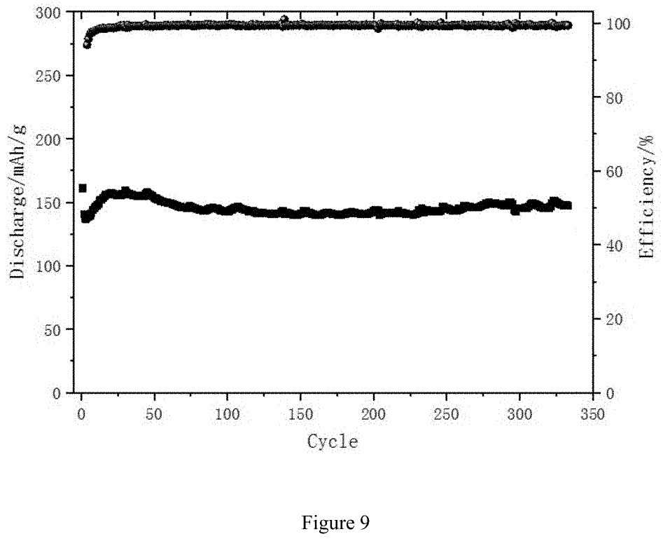

Example 2. The nanostructured carbon material produced in the Example 1 was used as the anode material for Li-ion batteries. The working electrode was made by mixing of 90 wt % the nanostructured carbon material fabricated, and 10 wt % polyvinylidene difluoride binder in N-methylprolinodone (NMP) as the solvent, followed by coating on a Cu foil and vacuum drying at 50° C. for 24 h. 1 M LiPF₆ dissolved in ethylene carbonate (EC) and diethyl carbonate (DEC), with a 1:1 ratio, was used as the electrolyte. No conductive carbon was used. The capacity of the nanostructured carbon material after 100 cycles at current densities of 75 and 187 mA g⁻¹ are shown in FIGS. 8 and 9, respectively. At 75 mAg⁻¹, the material exhibited a capacity of approximately 250 mAh g⁻¹. At a higher current density of 187 mA g⁻¹, the nanostructured carbon material showed a capacity of 150 mA g⁻¹. This performance was achieved without the addition of conductive additives. The results show that the prepared nanostructured carbon material has high conductivity and can be used as the active material or additive for electrodes used in lithium-ion batteries, aluminium ion batteries, supercapacitors or other energy storage devices (e.g. Na-ion batteries, K-ion batteries, Al-ion batteries).

In Table 2, the chlorine content of the sample is due to the presence of residual salt in the material. This salt can easily be recovered by further washing the sample with water and filtering the suspension. Ultra-pure carbon nanostructures can be obtained by washing the prepared nanostructured carbon material in acids such as HCl, H₂SO₄ or HNO₃.

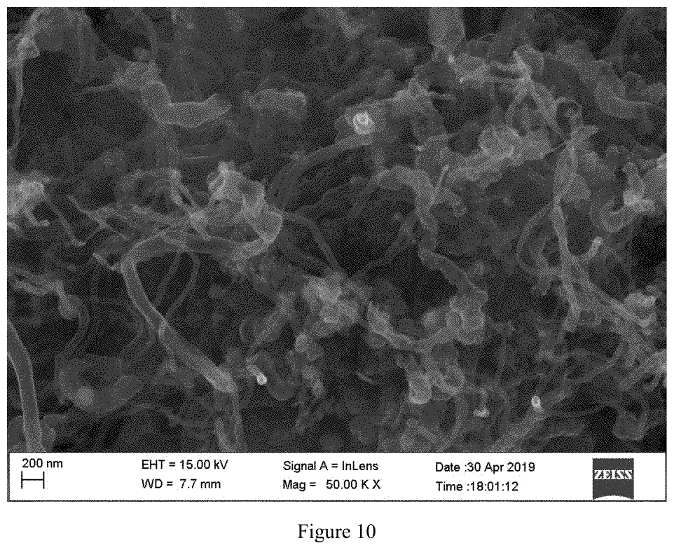

Example 3. 10 g of the nanostructured carbon material produced in Example 1 was washed with 50 ml HCl (50%) at 60° C., and the suspension was filtered using a filter paper with average pore size of about 5 μm. The filtrate was then dried at 250° C. for 2 h. The SEM micrograph of the purified nanostructured carbon material is shown in FIG. 10. The micrograph exhibits that the purified nanostructured carbon contains carbon nanotubes and nanofibres with a diameter of 10-200 nm with a volume fraction of 50% as well as spherical carbon nanoparticles with a diameter of 10-200 nm, and the volume fraction of 50%. The chemical composition of the purified nanostructured carbon material is shown in Table 3.

TABLE 3
Chemical composition of purified nanostructured carbon material.

| Element | wt % |
|---|---|
| C | 95.27 |
| O | 3.2 |
| Na | 0.12 |
| Al | 0.10 |
| Si | 0.87 |
| Cl | 0.2 |
| K | 0.1 |
| Ca | 0.12 |
| Fe | 0.02 |
| Total | 100.00 |

Example 4. 1 g of the purified nanostructured carbon material produced in Example 3 was washed with 10 ml HF solution with a mass concentration of 5% HF for 30 minutes. Then the suspension was filtered and the filtrate was dried at 250° C. for 2 h. The chemical composition of the extra purified nanostructured carbon material is shown in Table 4.

TABLE 4
Chemical composition of the extra purified
nanostructured carbon material.

| Element | wt % |
|---|---|
| C | 99.46 |
| O | 0.5 |
| Al | 0.01 |
| Si | 0.02 |
| Cl | 0.01 |
| Total | 100.00 |

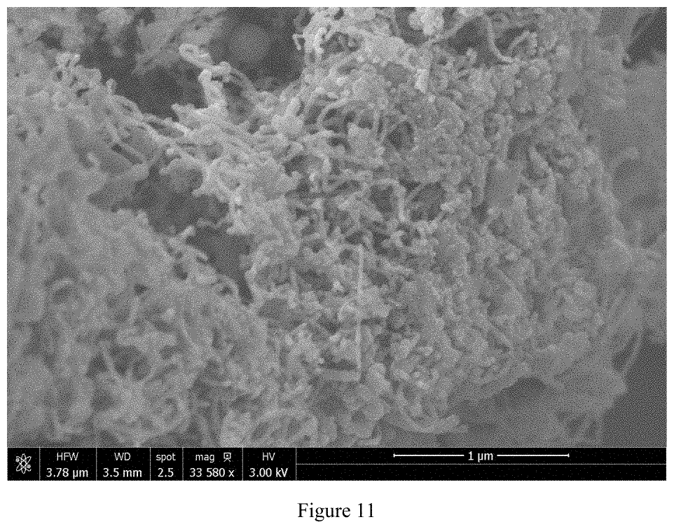

Example 5. The precursor material consisted of amorphous carbon, 3.2 wt % Fe₂O₃ and 3.2 wt % SiO₂. To prepare this precursor material, a mixture of the above mentioned materials was ground using a ball milling equipment. The particle size of the amorphous carbon, Fe₂O₃ and SiO₂ in the ball milled powder was 2 pin, 620 nm and 850 nm, respectively. The ball milled powder was compacted into a solid precursor material by using a cold isostatic press. The precursor material is then wrapped by a long molybdenum wire with a diameter of 1.5 mm. Then, the precursor material was placed in the molten salt and was processed for 30 min under the same conditions as explained in Example 1. The microstructure of the resulting product is shown in FIG. 11.

As it can be seen, the morphology of the product is in the form of an integrated mixture of carbon nanotubes with a diameter of 20 nm to 100 nm and spherical carbon particles with a diameter of 10 nm to 200 nm.

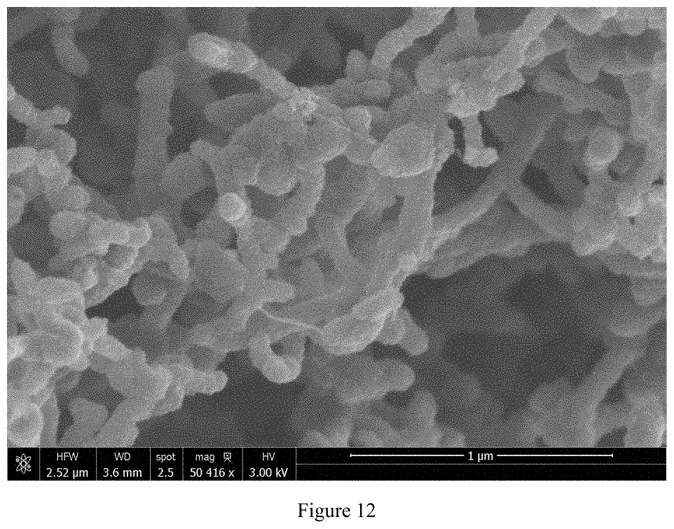

Example 6. The Example 5 was repeated, with the difference that the precursor material was made of crystalline graphite powder plus 5 wt % cobalt oxide (CoO) and 1.3 wt % Al₂O₃. The average particle sizes of the crystalline graphite powder, CoO and Al₂O₃ in the precursor material was 3.2 μm, 2.3 μm and 1.5 μm, respectively. The SEM morphology of the final product is shown in FIG. 12. The product includes a mixture of carbon nanotubes, carbon nanofibers and spherical carbon particles.

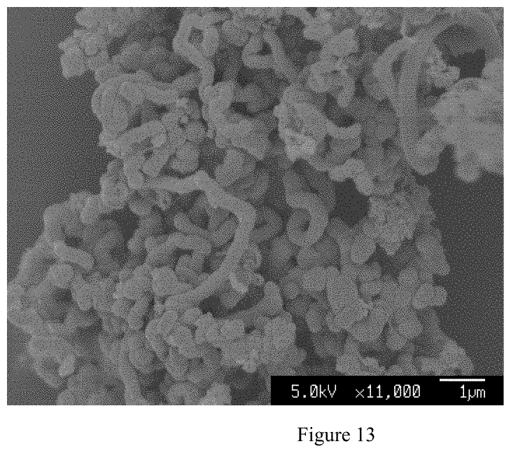

Example 7. The Example 5 was repeated, wherein the precursor material consisted of amorphous carbon powder plus 3 wt % Ni, 2 wt % Fe and 1.5 wt % Al. The process was conducted using sodium chloride salt at 850° C. for 40 min. The SEM morphology of the product is shown in FIG. 13. The product includes carbon nanotubes, carbon nanofibers and carbon nanoparticles.

1. Precursor materials for the preparation of nanostructured carbon materials, wherein a carbon phase and a non-carbon phase are comprised, the non-carbon phase is scattered in the carbon phase, the characteristic elements of the non-carbon phase include at least one of Fe, Ni, Si, Co, Na, Mg, Al, K and Ca elements, the characteristic element of the non-carbon phase in the precursor material has a mass percentage of 0.1 to 5%, and the characteristic elements of the non-carbon phase are in the form of single elements, or their oxides; the carbon phase is amorphous carbon or crystalline carbon; and the particle size of the single elements or the oxides of the characteristic elements in the non-carbon phase is in the range of 1 nm to 100 μm.

2. A method for preparing nanostructured carbon materials using precursor materials according to claim 1, wherein comprising the following steps: step 1, the precursor material (1) is wrapped by a wire (2) made of Mo, W, Ni or steel, the diameter of the wire (2) is 0.5-12 mm depending on the size of the precursor material (1), the end of the conductive rod A (3) is fixed in the precursor material (1), the wire (2) is connected with the conductive rod A (3) during winding, and the diameter of the conductive rod A (3) is 6 mm to 5 cm; step 2, the precursor material, that is wrapped in the conductive wire and connected to the conductive rod A, is placed on the ceramic disc (5) at the bottom of the reaction container (4), the reaction container (4) is filled with molten salt (6); the molten salt is one or a mixture of more than one salt from LiCl, NaCl, CaCl₂ or KCl, the reaction container (4) is made of graphite, Mo or W; step 3, the temperature of the molten salt is reached to 350° C. to 900° C., the conductive rod B (7) is connected to the reaction container (4), the conductive rod B (7) is made of the same material as the conductive rod A (3), the conductive rod A (3) is connected to the negative pole of the power supply, the conductive rod B (7) is connected to the positive pole of the power supply; step 4, according to the size of the precursor material, a direct current of 1 A to 10000 A is applied between the electrodes for 10 min to 20 h; after the molten salt is cooled, the salt is dissolved in water and the suspension is filtered to recover the nanostructure carbon material.

3. A method for preparing nanostructured carbon materials according to claim 2, wherein the ceramic disc (5) is made of Al₂O₃, MgO or ZrO₂.

4. A method for preparing nanostructured carbon material according to claim 2, wherein the material of the conductive rod B (7) and conductive rod A (3) is one of Mo, W, Ni or stainless steel.

5. A method for preparing nanostructured carbon materials according to claim 2, wherein the atmosphere in the reaction container in which the precursor material is reacted is one or a mixture of more than one gas selected from the group consisting of argon, air, nitrogen and helium.

6. A method for preparing nanostructured carbon material according to claim 2, wherein the nanostructured carbon materials obtained in step 4 include carbon nanoparticles ranging in size from 1 to 1000 nm, carbon nanofibers with diameters of 1 nm to 1000 nm and carbon nanotubes with an outer diameter of 1 nm to 1000 nm.
